(19) United States
(12) Patent Application Publication
(10) Pub. No.: US 2006/0051480 A1
(43) Pub. Date: Mar. 9, 2006

(54) Sweetener composition

(76) Inventor: Loren Miles, Van Nuys, CA (US)

Correspondence Address: Kevin D. Erickson;Pauley Petersen & Erickson, Suite 365, 2800 West Higgins Road, Hoffman Estates, IL, 60195, US

(21) Appl. No.: 11/218,947

(22) Filed: Sep. 2, 2005

Related U.S. Application Data
(60) Provisional application No. 60/607,009, filed on Sep. 3, 2004.
(60) Provisional application No. 60/658,513, filed on Mar. 3, 2005.

(51) Int. Cl. A23L 1/236

(52) U.S. Cl. 426/548

(57) ABSTRACT

A sweetener composition containing less than 1 gram of carbohydrates includes a monosaccharide derive polyol such as erythritol, a reduced calorie sweetener such as tagatose, a bulking agent such as polydextrose or maltodextrin and a high intensity, non-nutritive sweetener such as sucralose. The sweetness profile of the sweetener composition may be customized by adjusting the level of high intensity, non-nutritive sweetener included in the compositon.

### CROSS REFERENCE TO RELATED APPLICATIONS

This application claims the benefit of U.S. Provisional Application No. 60/607,009 filed on 3 Sep. 2004 and U.S. Provisional Application No. 60/658,513 filed on 3 Mar. 2005.

### FIELD OF THE INVENTION

The present invention relates to a sweetener composition. More particularly, the present invention relates to a zero or low calorie sweetener composition including a monosaccharide derived polyol such as erythritol, a reduced calorie sweetener such as tagatose, a bulking agent such as polydextrose and/or maltodextrin and a high intensity, non-nutritive sweetener such as sucralose that may be used in beverages and/or food products to replace or reduce high-calorie sweetener content.

### BACKGROUND OF THE INVENTION

According to statistics from numerous studies conducted by well known and respected national health organizations such as, for example, the Centers for Disease Control and Prevention, the prevalence of obesity has increased significantly over the last decade. Despite the rise in popularity of a number of diets including high protein/low carbohydrate diets and diets focused on reducing intake of high glycemic index carbohydrates, more people, particularly Americans, are now considered overweight or obese. Unfortunately, with an increase in obesity comes an increase in the likelihood of developing diabetes, hypertension, and cardiovascular disease amongst other life-threatening or altering diseases.

The most effective way to obtain and maintain permanent weight loss is by reducing calorie intake. Unfortunately, people are born liking the sensation of sweetness which makes it more difficult for them to resist ingesting foods and beverages which contain high-calorie sugars and sweeteners such as, for example, sucrose, fructose, honey and corn syrup. Additionally, food manufactures that produce low or reduced fat products often increase the sugar or sweetener content of their products to offset the loss of taste and texture typically associated with reducing fat content.

One solution for addressing these issues is the development of zero or low calorie sweeteners or sugar substitutes that can be used in foods and/or beverages to replace or reduce high calorie sweetener or sugar content. Examples of such zero or low calorie sweeteners include, for example, aspartame, acesulfame-K, sucralose and saccharin. However, not all zero or low calorie sweeteners or sugar substitutes are suitable for all applications. For example, some sweeteners may suitably used in beverages such as sodas and drink mixes but are not suitable for use in baked goods because exposure to elevated temperatures during baking can degrade the sweetener or reduce the sweetening ability of the sweetener. Other sweeteners, for example, may be suitable for use in solid food products or baked goods but may not be appropriate for use in beverages and drink mixes due to limitations on solubility. Additionally, some sweeteners are derived by chemically altering a sugar compound such as sucrose.

In view of the above, there is a need and a demand for a sweetener composition. In particular, there is a need and a demand for a zero or low calorie sweetener composition that may be utilized in food products such as baked goods, snack foods, diary products and the like and in beverages and beverage mixes. There is a further need and a demand for a sweetener composition which reduces the risk of tooth decay, is diabetic safe, cooks and tastes like sugar, and includes less than 1 gram of carbohydrates.

### SUMMARY OF THE INVENTION

A general objective of the invention is to provide a sweetener composition.

A more specific objective of the invention is to provide a zero or low calorie sweetener composition that may be used in food products and/or beverages to replace or reduce high calorie sugar or sugar sweetener content.

A further objective of the invention is to provide a sweetener composition that tastes and cooks like sugar, is diabetic safe, reduces the risk of tooth decay and includes less than 1 gram of carbohydrates.

An additional objective of the invention is to provide a sweetener composition that includes ingredients that promote desired prebiotic effects.

The general object of the invention can be attained, at least in part, through a sweetener composition containing less than 1 gram of carbohydrates which includes a monosaccharide derived polyol, a reduced calorie sweetener, a bulking agent and a high intensity, non-nutritive sweetener.

In accordance with certain other preferred embodiments, the sweetener composition includes about 40 to about 70 composition weight percent monosaccharide derived polyol, about 5 to about 35 composition weight percent reduced calorie sweetener, about 15 to about 40 composition weight percent bulking agent and up to about 3 composition weight percent high intensity, non-nutritive sweetener.

In accordance with certain preferred embodiments, the sweetener composition includes erythritol, tagatose, maltodextrin and sucralose.

In accordance with a further preferred embodiment of the invention, the sweetener composition includes about 50 to about 60 composition weight percent erythritol, about 15 to about 25 composition weight percent tagatose, about 25 to about 35 composition weight percent maltodextrin, about 0.1 to about 3 composition weight percent sucralose.

The prior art has generally failed to provide a zero or low calorie sweetener composition including a monosaccharide derived polyol such as erythritol, a reduced calorie sweetener such as tagatose, a bulking agent such as polydextrose and/or maltodextrin and a high intensity, non-nutritive sweetener such as sucralose that is as effective as desired in satisfying one or more of the above identified needs or demands.

Other objects and advantages will be apparent to those skilled in the art from the following description.

### DESCRIPTION

The present invention provide a zero or low calorie sweetener composition suitable for use in food products and/or beverages. Such sweetener composition includes a monosaccharide derived polyol, a reduced calorie sweetener, a bulking agent and a high intensity, non-nutritive sweetner. The present invention further provides a sweetener composition containing less than 1 gram of carbohydrates. The present invention additionally provides a sweetener composition that tastes and cooks like sugar, is diabetic safe and reduces the risk of tooth decay.

It is generally desirable in the production of sweeteners and sugar substitutes to prepare sweeteners and sweetener compositions that are as close as possible to sugar in taste, texture and usability. More specifically, it is generally desirable to prepare sweeteners and sweetener compositions that provide an appropriate level of sweetness, have an appropriate texture and mouthfeel, have a positive impact on product appearance, have limited negative aftertaste, and provide flavor enhancing and/or masking abilities, stability, and the ability brown. However, due to the varying properties of different sweetening materials it is often difficult to achieve as suitable a result as desired when combining such materials. This is generally believed to be due to the synergistic effects of mixing various sweetening compounds wherein the sweetness of the mixture is often greater than the apparent sweetness of the individual components. It has now been discovered that an appropriate blend of a monosaccharide derived polyol, a reduced calorie sweetener, a bulking agent and a high intensity, non-nutritive sweetener can result in a sweetener product that has many of the desirable properties of sugar without the added calories.

In accordance with the invention, a sweetener composition for use in beverages and/or food products includes:
about 40 to about 70 composition weight percent monosaccharide derived polyol, suitably about 50 to about 60 composition weight percent monosaccharide derived polyol;
about 5 to about 35 composition weight percent reduced calorie sweetener, suitably about 15 to about 25 composition weight percent reduced calorie sweetener;
about 15 to about 45 composition weight percent bulking agent, suitably about 25 to about 35 composition weight percent bulking agent; and
up to about 3 composition weight percent high intensity, non-nutritive sweetener, suitably about 0.1 to about 3 composition weight percent.

Suitably, the sweetener composition may include less than about 1 gram of carbohydrates. The sweetener composition may suitably contain less than about 3 calories/gram, suitably less than about 2 calories/gram and advantageously less than about 1 calorie/gram.

Suitable monosaccharide derived polyols include erythritol, sorbitol, manitol, xylitol and combinations thereof. Suitably, the sweetener composition may include erythritol. Erythritol may advantageously be used in the sweetener composition due to its low caloric value (up to 0.2 kcal/g), stability against heat and acidity, low hygroscopicity, and desirable crystalline properties. Additionally, erythritol may have a higher digestive tolerability compared to other mono-, di- or polysaccharide derived polyols.

Suitably, the reduced calorie sweetener includes tagatose also known as D-tagatose. Tagatose may be advantageously used in the sweetener composition due to its high solubility, high melting point, quick crystallization, stability over a pH range of 3 to 7, and its Malliard reactivity (browning). Advantageously, tagatose has a bulk comparable to sugar. Additionally, tagatose may promote desirable prebiotic effects in the digestive system. In particular, tagatose has been shown to promote growth of two bacteria that are recognized to improve colon health. Tagatose may also stimulate colonic bacteria fermentation and production of short chain fatty acids such as butyrate which may promote colon heath and control disease conditions.

Suitable bulking agents for use in the sweetener composition include polydextrose, maltodextrin and combinations thereof. Polydextrose may advantageously be used in the sweetener composition to serve as a humectant, provide solids, decrease water activity and control crystallization. Additionally, polydextose may provide an economical source of prebiotic fiber which may promote digestive system health. Maltodextrin may be advantageously used in the composition due to its easy digestibility and cold water solubility. Maltodextrin may be derived by hydrolysis of corn, potato or rice starch. For certain applications, the sweetener composition may adjusted to include a maltodextrin derived from a particular source to render the composition safe for use by individuals suffering from food allegies to corn, wheat, potatoes or rice, and/or celiac's disease.

Suitably, the high intensity, non-nutritive sweetener includes sucralose. Sucralose may advantageously used in the composition in relatively minor concentrations such as about 0.1 composition weight percent while providing enhanced sweetness. Additionally, sucralose when used in combination with erythritol, tagatose and maltodextrin may provide a sweetener composition that has an adjustable sweetness profile depending upon the desired end use of the sweetener composition. Further, sucralose may be advantageously utilized in the sweetener composition due to its heat stability.

Advantageously, the sweetener composition may include additional compounds or sweeteners which may enhance the flavor, stability, and processability of the sweetener composition. For example, the sweetener composition may include an additional sweetener such as a reduced calorie sweetener, a sugar-derived sweetener, a disaccharide or polysaccharide derived polyol, and/or a non-nutritive sweetener. Suitably, the additional sweetener is present in a minor amount. Additionally, the sweetener composition may include a processing and/or stability aids such as, for example, silica.

In accordance with one embodiment of the invention, the sweetener composition may consist essentially of about 52 to about 54 composition weight percent erythritol, about 17 to about 18 composition weight percent tagatose, about 28 to about 29 composition weight percent maltodextrin and about 0.1 to about 2.5 composition weight percent sucralose.

A method for making the sweetener composition includes preparing a blend of a monosaccharide derived polyol, a reduced calorie sweetener and a bulking agent, and adjusting the sweetness of the composition by adding a select amount of a high-intensity, non-nutritive sweetener.

The invention is described in further detail in connection with the following examples which illustrate or simulate various aspects involved in the practice of the invention. It is to be understood that all changes that come within the spirit of the invention are desired to be protected and thus the invention is not to be construed as limited by these examples.

### EXAMPLES

Table 1 illustrates a sweetener composition including polydextrose as the bulking agent.

TABLE 1

| | Composition | Single Serving |
|---|---|---|
| Ingredient | Weight Percent | Weight (mg) |
| Erythritol | 52.53 | 1050.5 |
| Polydextrose | 28.37 | 567.4 |
| Tagatose | 17.73 | 354.6 |
| Silica | 1.00 | 20.0 |
| Sucralose | 0.38 | 7.5 |

Tables 2-5 illustrate sweetener compositions including maltodextrin as the bulking agent and having varying levels of sucralose.

TABLE 2

| | Composition | Single Serving |
|---|---|---|
| Ingredient | Weight Percent | Weight (mg) |
| Erythritol | 53.16 | 722.8 |
| Maltodextrin | 28.70 | 390.4 |
| Tagatose | 17.94 | 244.0 |
| Sucralose | 0.20 | 2.75 |

TABLE 3

| | Composition | Batch |
|---|---|---|
| Ingredient | Weight Percent | Weight (kg) |
| Erythritol | 53.20 | 53.16 |
| Maltodextrin | 28.72 | 28.70 |
| Tagatose | 17.95 | 17.94 |
| Sucralose | 0.13 | 0.133 |

TABLE 4

| | Composition | Single Serving |
|---|---|---|
| Ingredient | Weight Percent | Weight (mg) |
| Erythritol | 52.61 | 53.16 |
| Maltodextrin | 28.40 | 28.70 |
| Tagatose | 17.75 | 17.94 |
| Sucralose | 1.24 | 1.25 |

TABLE 5

| | Composition | Single Serving |
|---|---|---|
| Ingredient | Weight Percent | Weight (mg) |
| Erythritol | 51.96 | 53.16 |
| Maltodextrin | 28.05 | 28.70 |
| Tagatose | 17.54 | 17.94 |
| Sucralose | 2.44 | 2.50 |

While in the foregoing specification this invention has been described in relation to certain preferred embodiments thereof, and many details have been set forth for purposes of illustration, it will be apparent to those skilled in the art that the sweetener composition according to this invention is susceptible to additional embodiments and that certain of the details described herein can be varied significantly without departing from the basic principles of the invention.

I claim:

1. A sweetener composition comprising:
about 40 to about 70 composition weight percent monosaccharide derived polyol;
about 5 to about 35 composition weight percent reduced calorie sweetener;
about 15 to about 45 composition weight percent bulking agent; and
up to about 3 composition weight percent high intensity, non-nutritive sweetener,
wherein the sweetener composition contains less than 1 gram of carbohydrates.

2. The sweetener composition of claim 1, wherein the monosaccharide derived polyol is selected from the group consisting of erythritol, sorbitol, manitol, xylitol and combinations thereof.

3. The sweetener composition of claim 1, wherein the monosaccharide derived polyol comprises erythritol.

4. The sweetener composition of claim 1, wherein the reduced calorie sweetener comprises tagatose.

5. The sweetener composition of claim 1, wherein the bulking agent is selected from the group consisting of polydextrose, maltodextrin and combinations thereof.

6. The sweetener composition of claim 5, wherein the bulking agent comprises maltodextrin.

7. The sweetener composition of claim 1, wherein the high intensity, non-nutritive sweetener comprises sucralose.

8. The sweetener composition of claim 1, further comprising an additional sweetener selected from the group consisting of a reduced calorie sweetener, a sugar-derived sweetener, a non-nutritive sweetener, or a combination thereof.

9. The sweetener composition of claim 1, further comprising a processing aid.

10. A sweetener composition comprising:
about 50 to about 60 composition weight percent erythritol;
about 15 to about 25 composition weight percent tagatose;
about 25 to about 35 composition weight percent maltodextrin; and
about 0.1 to about 3 composition weight percent sucralose, wherein the sweetener composition contains less than 1 gram of carbohydrates.

11. The sweetener composition of claim 10, wherein the composition contains less than about 3 calories/gram.

12. The sweenter composition of claim 10, wherein the composition contains less than about 2 calories/g

13. The sweetener composition of claim 10, wherein the composition contains less than about 1 calorie/gram.

14. The sweetener composition of claim 10 consisting essentially of:
about 52 to about 54 composition weight percent erythritol;
about 17 to about 18 composition weight percent tagatose;
about 28 to about 29 composition weight percent maltodextrin; and
about 0.1 to about 2.5 composition weight percent sucralose,
wherein the sweetener composition contains less than about 1 gram of carbohydrate.

15. A method for making a sweetener composition comprising;
preparing a blend of a monosaccharide derived polyol, a reduced calorie sweetener, a bulking agent; and
adjusting the sweetness of the sweetener composition by adding a select amount of a high intensity, non-nutritive sweetener,
wherein the sweetener composition contains less than 1 gram of carbohydrates.

16. The method of claim 15, wherein the blend comprises about 40 to about 70 composition weight percent erythritol, about 5 to about 35 composition weight percent tagatose and 15 to about 45 composition weight percent maltodextrin.

17. The method of claim 15, wherein the sweetness is adjusted by adding up to about 3 composition weight percent of the high intensity, non-nutritive sweetener.

18. The method of claim 15, wherein the high intensity, non-nutritive sweetener comprises sucralose.

19. The method of claim 18, wherein the sweetness of the blend is adjusted by adding about 0.1 to about 3 composition weight percent sucralose.
